(19) United States
(12) Patent Application Publication
(10) Pub. No.: US 2024/0141193 A1
(43) Pub. Date: May 2, 2024

(54) INKJET INK

(71) Applicant: KYOCERA Document Solutions Inc., Osaka (JP)

(72) Inventor: Masatoshi NAKAGOMI, Osaka (JP)

(73) Assignee: KYOCERA Document Solutions Inc., Osaka (JP)

(21) Appl. No.: 18/492,275

(22) Filed: Oct. 23, 2023

(30) Foreign Application Priority Data
Oct. 31, 2022 (JP) 2022-174560

(51) Int. Cl. C09D 11/324; C09D 11/037; C09D 11/107

(52) U.S. Cl. CPC C09D 11/324; C09D 11/037; C09D 11/107

(57) ABSTRACT

An inkjet ink includes a self-dispersing pigment, specific particles and an aqueous medium. The specific particles include a pigment and a resin. In the specific particles, the mass ratio of the resin to the pigment is equal to or greater than 1.2 and equal to or less than 2.0. The resin includes a styrene-(meth)acrylic resin. The volume median diameter of the specific particles is equal to or greater than 100 nm and equal to or less than 170 nm.

### INCORPORATION BY REFERENCE

This application is based upon and claims the benefit of priority from the corresponding Japanese Patent Application No. 2022-174560 filed on Oct. 31, 2022, the entire contents of which are incorporated herein by reference.

### BACKGROUND

The present disclosure relates to inkjet inks.

Inkjet inks are required to be able to form images which have a desired image density and excellent abrasion resistance.

### SUMMARY

An inkjet ink according to the present disclosure includes a self-dispersing pigment, specific particles and an aqueous medium. The specific particles include a pigment and a resin. In the specific particles, the mass ratio of the resin to the pigment is equal to or greater than 1.2 and equal to or less than 2.0. The resin includes a styrene-(meth)acrylic resin. The volume median diameter of the specific particles is equal to or greater than 100 nm and equal to or less than 170 nm.

Further features of the present disclosure and specific advantages obtained by the present disclosure will become clearer from the description of an embodiment described below.

### DETAILED DESCRIPTION

An embodiment of the present disclosure will be described below.

A conventional technique will be described before the description of the embodiment. In the conventional technique, for example, an inkjet ink is proposed which includes at least a dispersing member capable of dispersing a pigment in water and polymer fine particles.

However, even with the conventional inkjet ink as described above, it is difficult to form images which have a desired image density and excellent abrasion resistance.

The present disclosure is made in view of the problem described above, and an object of the present disclosure is to provide an inkjet ink capable of forming images which have a desired image density and excellent abrasion resistance.

In the following description, unless otherwise specified, the measured value of a volume median diameter (D₅₀) is a value measured using a dynamic light scattering particle size distribution measuring device (“Zetasizer Nano ZS” made by Malvern Panalytical Ltd).

Unless otherwise specified, the measured value of an acid value is a value measured according to “JIS (Japanese Industrial Standard) K0070-1992”.

In the present specification, “acrylic” and “methacrylic” may be collectively referred to as “(meth)acrylic”. Each of components described in the present specification may be used alone or in combination of two or more.

### Inkjet Ink

An inkjet ink according to the embodiment of the present disclosure (which may also be referred to as the ink below) includes a self-dispersing pigment, specific particles and an aqueous medium. The specific particles include a pigment and a resin. In the specific particles, the mass ratio of the resin to the pigment is equal to or greater than 1.2 and equal to or less than 2.0. The resin includes a styrene-(meth)acrylic resin. The volume median diameter of the specific particles is equal to or greater than 100 nm and equal to or less than 170 nm.

Examples of a recording medium on which an image is formed with the ink of the present disclosure include recording media made of paper, resin, metal, glass and ceramics. Among them, for an image formed on an impermeable recording medium, particularly excellent abrasion resistance is required. Hence, the ink of the present disclosure is suitable for the formation of an image on an impermeable recording medium such as a resin film.

The ink of the present disclosure has the configuration described above to be able to form images which have a desired image density and excellent abrasion resistance. The reason is presumed as follows. A known ink may include a self-dispersing pigment in terms of increasing the image density of an image to be formed. However, the known ink which includes the self-dispersing pigment tends to have insufficient abrasion resistance. By contrast, binder resin particles are further added to the known ink which includes the self-dispersing pigment, and thus the abrasion resistance of the image to be formed can be enhanced. However, in the known ink which includes the self-dispersing pigment and the binder resin particles, due to the presence of the binder resin particles, the amount of pigment included in the formed image is relatively reduced, with the result that the image density may be lowered. As described above, in the known ink, there is a trade-off between the image density and the abrasion resistance of the formed image.

By contrast, the ink of the present disclosure includes, in addition to the self-dispersing pigment, the specific particles including the pigment and the resin. Since in the specific particles, the mass ratio of the resin to the pigment is relatively high (1.2 or more and 2.0 or less), the specific particles function as binder resin particles to provide abrasion resistance to an image which is formed with the ink of the present disclosure. Since the specific particles have an appropriate volume median diameter, the self-dispersing pigment is appropriately coated by the specific particles in the image formed with the ink of the present disclosure, and thus the abrasion resistance of the image can be optimized. Furthermore, since the specific particles include not only the resin but also a certain amount of pigment, the image density of the image formed with the ink of the present disclosure is unlikely to be lowered. As described above, the ink of the present disclosure includes the self-dispersing pigment and the specific particles, and thus it is possible to satisfy both the image density and the abrasion resistance of the formed image. The details of the ink of the present disclosure will be described below.

### Self-Dispersing Pigment

A self-dispersing pigment is a pigment which directly or indirectly binds a hydrophilic group to its surface by physical surface treatment or chemical surface treatment. The self-dispersing pigment provides a desired image density to an image to be formed.

Although the hydrophilic group on the surface of the particles of the self-dispersing pigment is not particularly limited, for example, one or more hydrophilic groups represented by chemical formulae selected from the group consisting of —OM, —COOM, —CO—, —SO₃M, —SO₂M, —SO₂NH₂, —RSO₂M, —PO₃HM, —PO₃M₂, —SO₂NHCOR, —NH₃ and —NR₃ are mentioned. In each of the chemical formulae, M represents a hydrogen atom, an alkali metal, ammonium, a phenyl group optionally substituted with a substituent or organic ammonium. R represents an alkyl group having one or more and twelve or less carbon atoms or an aryl group having one or more and twelve or less carbon atoms and optionally substituted with a substituent. Examples of the aryl group include a phenyl group and a naphthyl group.

Among them, as the hydrophilic group, an anionic functional group is preferable. In other words, as the self-dispersing pigment, an anionic self-dispersing pigment which has an anionic functional group on its surface is preferable. The anionic functional group is not particularly limited as long as the anionic functional group is a functional group which is negatively charged in the aqueous medium, and examples thereof include a carboxy group, a sulfonic acid group, a phosphonic acid group and a phosphate group. The anionic functional group may form salts (for example, an ammonium salt and a metal salt) together with a cation.

The self-dispersing pigment can be prepared by performing known physical surface treatment or chemical surface treatment on a pigment which does not have self-dispersibility. Examples of the physical surface treatment include vacuum plasma treatment and the like. Examples of the chemical surface treatment include wet oxidation treatment in which oxidation is performed in water with an oxidizing agent, treatment to bind p-aminobenzoic acid to the pigment surface (in this treatment, carboxy groups are bound to the pigment surface via phenyl groups) and the like.

As the self-dispersing pigment, a commercially available product can also be used. Examples of the commercially available product of the self-dispersing pigment include: CAB-O-Jet (registered trademark) series made by Cabot Corporation. (for example, CAB-O-Jet (registered trademark) 200, 300, 400, 250C, 260M, 270Y, 450C, 465M, 470Y and 480M); IJX series made by Cabot Corporation. (for example, IJX-157, -253, -266, -273, -444 and -55); BONJET (registered trademark) series made by ORIENT CHEMICAL INDUSTRIES CO., LTD. (for example, BONJET (registered trademark) CW-1, CW-1S, CW-2 and CW-3); and Aqua-Black (registered trademark) series made by TOKAI CARBON CO., LTD. (for example, Aqua-Black (registered trademark) 001 and 162).

Examples of the pigment (pigment which does not have self-dispersibility) serving as a raw material of the self-dispersing pigment include a yellow pigment, an orange pigment, a red pigment, a blue pigment, a violet pigment and a black pigment. Examples of the yellow pigment include C.I. pigment yellows (1, 2, 3, 12, 13, 14, 16, 17, 55, 73, 74, 75, 83, 93, 95, 97, 98, 109, 110, 114, 120, 128, 129, 138, 139, 150, 151, 154, 155, 173, 180, 185 and 193) and the like.

Examples of the orange pigment include C.I. pigment oranges (34, 36, 43, 61, 63 and 71) and the like.

Examples of the red pigment include C.I. pigment reds (5, 7, 12, 48, 48 (more specifically 48:1), 57, 112, 122, 123, 146, 168, 184 and 202) and the like.

Examples of the blue pigment include C.I. pigment blues (1, 2, 3, 15 (more specifically 15:3 and 15:4), 16, 22 and 60) and the like.

Examples of the violet pigment include C.I. pigment violets (19, 23, 33 and 1960) and the like.

Examples of the black pigment include conductive carbon black, carbon black and the like. Examples of the conductive carbon black include: No. 2300, No. 900, MCF88, No. 33, No. 40, No. 45, No. 52, MA7, MA8, MA100, No. 2200B and the like made by Mitsubishi Chemical Corporation; Raven (registered trademark) (5750, 5250, 5000, 3500, 1255 and 700) and the like made by Columbia Chemical; and Regal (registered trademark) (400R, 330R and 660R), Mogul (registered trademark) L, Monarch (registered trademark) (700, 800, 880, 900, 1000, 1100, 1300 and 1400), BLACK PEARLS (registered trademark) 2000, VULCAN (registered trademark) XC-72, VULCAN (registered trademark) P, STERLIB (registered trademark) C and the like made by Cabot Corporation. Examples of the carbon black include Color Black (FW1, FW2, FW2V, FW18, FW200, S150, S160 and S170), Printex (registered trademark) (35, U, V and 140U), Special Black (4, 4A, 5 and 6) and the like made by Orion Engineered Carbons S.A.

In the ink of the present disclosure, the content of the self-dispersing pigment is preferably equal to or greater than 2.0% by mass and equal to or less than 10.0% by mass, and more preferably equal to or greater than 4.0% by mass and equal to or less than 6.0% by mass. The content of the self-dispersing pigment is set equal to or greater than 2.0% by mass, and thus it is easier to form images which have a desired image density. The content of the self-dispersing pigment is set equal to or less than 10.0% by mass, and thus it is possible to optimize the fluidity of the ink of the present disclosure.

### Specific Particles

The specific particles include the pigment (for example, the pigment which does not have self-dispersibility) and the resin. The specific particles include, for example, a matrix formed of the resin and the pigment dispersed in the matrix. The specific particles provide, while maintaining the image density of an image formed with the ink of the present disclosure, abrasion resistance to the image. The specific particles are preferably a material obtained by kneading and pulverizing the pigment and the resin (hereinafter also referred to as the kneaded/pulverized material).

The specific particles preferably include only the pigment and the resin. Specifically, the total content of the pigment and the resin in the specific particles is preferably equal to or greater than 90% by mass, more preferably equal to or greater than 99% by mass and further preferably 100% by mass.

The volume median diameter (D₅₀) of the specific particles is equal to or greater than 100 nm and equal to or less than 170 nm, and preferably equal to or greater than 110 nm and equal to or less than 140 nm. The volume median diameter of the specific particles is set equal to or greater than 100 nm, and thus in the image formed with the ink of the present disclosure, the self-dispersing pigment can be reliably coated with the specific particles. Consequently, it is possible to provide abrasion resistance to the image formed with the ink of the present disclosure. The volume median diameter of the specific particles is set equal to or less than 170 nm, and thus in the image formed with the ink of the present disclosure, it is possible to suppress the excessive coating of the self-dispersing pigment with the specific particles. Consequently, it is possible to provide a desired image density to the image formed with the ink of the present disclosure.

In the ink of the present disclosure, the content of the specific particles is preferably equal to or greater than 2.0% by mass and equal to or less than 10.0% by mass, and more preferably equal to or greater than 4.0% by mass and equal to or less than 6.0% by mass. The content of the specific particles is set equal to or greater than 2.0% by mass, and thus in the image formed with the ink of the present disclosure, the self-dispersing pigment can be reliably coated with the specific particles. Consequently, it is possible to provide further appropriate abrasion resistance to the image formed with the ink of the present disclosure. The content of the specific particles is set equal to or less than 10.0% by mass, and in the image formed with the ink of the present disclosure, it is possible to suppress the excessive coating of the self-dispersing pigment with the specific particles. Consequently, it is possible to further appropriately provide a desired image density to the image formed with the ink of the present disclosure.

In the ink of the present disclosure, the mass ratio of the specific particles to the self-dispersing pigment is preferably equal to or greater than 0.5 and equal to or less than 2.0, and more preferably equal to or greater than 0.8 and equal to or less than 1.2. The mass ratio of the specific particles is set equal to or greater than 0.5, and thus in the image formed with the ink of the present disclosure, the self-dispersing pigment can be reliably coated with the specific particles. Consequently, it is possible to provide further appropriate abrasion resistance to the image formed with the ink of the present disclosure. The content of the specific particles is set equal to or less than 2.0, and thus in the image formed with the ink of the present disclosure, it is possible to suppress the excessive coating of the self-dispersing pigment with the specific particles. Consequently, it is possible to further appropriately provide a desired image density to the image formed with the ink of the present disclosure.

### Pigment

As the pigment included in the specific particles, the same compounds as the examples of the pigment which does not have self-dispersibility in the above description are mentioned.

### Resin

Examples of the resin included in the specific particles include a styrene-(meth)acrylic resin, a (meth)acrylic resin, a polyester resin, a urethane resin and a styrene-butadiene resin. As the resin, the styrene-(meth)acrylic resin is preferable. The styrene-(meth)acrylic resin includes a styrene unit and a repeating unit derived from a (meth)acrylic acid alkyl ester (which may also be referred to as a (meth)acrylic acid alkyl ester unit below). Examples of the (meth)acrylic acid alkyl ester include methyl (meth)acrylate, ethyl (meth)acrylate, propyl (meth)acrylate and n-butyl (meth)acrylate.

Furthermore, the styrene-(meth)acrylic resin preferably includes a repeating unit derived from (meth)acrylic acid (which may also be referred to as a (meth)acrylic acid unit). The styrene-(meth)acrylic resin includes the repeating unit derived from (meth)acrylic acid to be able to provide appropriate hydrophilicity to the specific particles.

In the styrene-(meth)acrylic resin, the content of the styrene unit in all the repeating units is preferably equal to or greater than 15.0% by mass and equal to or less than 75.0% by mass, and more preferably equal to or greater than 30.0% by mass and equal to or less than 50.0% by mass.

In the styrene-(meth)acrylic resin, the content of the (meth)acrylic acid unit in all the repeating units is preferably equal to or greater than 2.0% by mass and equal to or less than 20.0% by mass, and more preferably equal to or greater than 7.0% by mass and equal to or less than 13.0% by mass. The content of the (meth)acrylic acid unit is set equal to or greater than 2.0% by mass and equal to or less than 20.0% by mass, and thus it is possible to provide appropriate hydrophilicity to the specific particles.

In the styrene-(meth)acrylic resin, the content of the (meth)acrylic acid alkyl ester unit in all the repeating units is preferably equal to or greater than 15.0% by mass and equal to or less than 75.0% by mass, and more preferably equal to or greater than 30.0% by mass and equal to or less than 50.0% by mass.

As raw material monomers for the styrene-(meth)acrylic resin, combinations of styrene and (meth)acrylic acid, methyl (meth)acrylate and n-butyl (meth)acrylate are preferable, and combinations of styrene and methyl methacrylate, n-butyl acrylate and methacrylic acid are preferable.

The styrene-(meth)acrylic resin included in the specific particles is preferably neutralized with a basic compound. Examples of the basic compound include NaOH and KOH. The amount of basic compound used for neutralizing the styrene-(meth)acrylic resin is preferably equal to or greater than 0.6 times and equal to or less than 1.0 times, and more preferably equal to or greater than 0.7 times and equal to or less than 0.9 times the neutralization equivalent of the styrene-(meth)acrylic resin.

The mass average molecular weight (Mw) of the styrene-(meth)acrylic resin is preferably equal to or greater than 5,000 and equal to or less than 100,000, and more preferably equal to or greater than 15,000 and equal to or less than 25,000.

In the specific particles, the mass ratio of the resin to the pigment is equal to or greater than 1.2 and equal to or less than 2.0, and preferably equal to or greater than 1.2 and equal to or less than 1.5. The mass ratio of the resin to the pigment is set equal to or greater than 1.2, and thus the ink of the present disclosure can provide sufficient abrasion resistance to the image to be formed. The mass ratio of the resin to the pigment is set equal to or less than 2.0, and thus the ink of the present disclosure can provide sufficient abrasion resistance to the image to be formed. The mass ratio of the resin to the pigment can be measured by a method described in Examples or a method corresponding to this method.

### Aqueous Medium

The aqueous medium included in the ink of the present disclosure is a medium which includes water. The aqueous medium may function as a solvent or may function as a dispersion medium. As a specific example of the aqueous medium, an aqueous medium which includes water and a water-soluble organic solvent is mentioned.

### Water

The content of water in the ink of the present disclosure is preferably equal to or greater than 25.0% by mass and equal to or less than 80.0% by mass, and more preferably equal to or greater than 40.0% by mass and equal to or less than 60.0% by mass.

Examples of the water-soluble organic solvent include a glycol compound, a glycol ether compound, a lactam compound, a nitrogen-containing compound, an acetate compound, thiodiglycol, glycerin and dimethyl sulfoxide.

Examples of the glycol compound include ethylene glycol, 1,3-propanediol, propylene glycol, 1,2-pentanediol, 1,5-pentanediol, 1,2-octanediol, 1,8-octanediol, 3-methyl-1,3-butanediol, 3-methyl-1,5-pentanediol, diethylene glycol, triethylene glycol and tetraethylene glycol.

Examples of the glycol ether compound include diethylene glycol diethyl ether, diethylene glycol monobutyl ether, ethylene glycol monomethyl ether, ethylene glycol monobutyl ether, diethylene glycol monomethyl ether, diethylene glycol monoethyl ether, diethylene glycol diethyl ether, triethylene glycol monomethyl ether, triethylene glycol monoethyl ether, triethylene glycol monobutyl ether and propylene glycol monomethyl ether.

Examples of the lactam compound include 2-pyrrolidone and N-methyl-2-pyrrolidone.

Examples of the nitrogen-containing compound include 1,3-dimethylimidazolidinone, formamide and dimethylformamide.

Examples of the acetate compound include diethylene glycol monoethyl ether acetate.

As the water-soluble organic solvent, the glycol compound is preferable, and ethylene glycol and diethylene glycol are more preferable.

The content of the water-soluble organic solvent in the ink of the present disclosure is preferably equal to or greater than 15.0% by mass and equal to or less than 50.0% by mass, and more preferably equal to or greater than 30.0% by mass and equal to or less than 40.0% by mass.

The content of ethylene glycol in the ink of the present disclosure is preferably equal to or greater than 5.0% by mass and equal to or less than 40.0% by mass, and more preferably equal to or greater than 15.0% by mass and equal to or less than 25.0% by mass.

The content of diethylene glycol in the ink of the present disclosure is preferably equal to or greater than 3.0% by mass and equal to or less than 30.0% by mass, and more preferably equal to or greater than 10.0% by mass and equal to or less than 20.0% by mass.

The ink of the present disclosure preferably includes, as the water-soluble organic solvent, only water, ethylene glycol and diethylene glycol. The total content of water, ethylene glycol and diethylene glycol in the water-soluble organic solvent is preferably equal to or greater than 90.0% by mass, more preferably equal to or greater than 99.0% by mass and further preferably equal to or greater than 100% by mass.

### Surfactant

The ink of the present disclosure preferably further includes a surfactant. The surfactant optimizes the compatibility and dispersion stability of components included in the ink of the present disclosure. The surfactant provides wettability to the ink of the present disclosure on the recording medium. As the surfactant for the ink of the present disclosure, a nonionic surfactant is preferable.

Examples of the nonionic surfactant in the ink of the present disclosure include an acetylene glycol surfactant (surfactant including an acetylene glycol compound), a silicone surfactant (surfactant including a silicone compound) and a fluorosurfactant (surfactant including a fluororesin or a fluorine-containing compound). Examples of the acetylene glycol surfactant include an ethylene oxide adduct of acetylene glycol and a propylene oxide adduct of acetylene glycol.

The content of the surfactant in the ink of the present disclosure is preferably equal to or greater than 0.1% by mass and equal to or less than 2.0% by mass, and more preferably equal to or greater than 0.2% by mass and equal to or less than 0.5% by mass.

### Other Components

The ink of the present disclosure may further include, as necessary, known additives (more specifically, for example, a dissolution stabilizer, an anti-drying agent, an antioxidant, a viscosity adjuster, a pH adjuster and an antifungal agent).

### Method for Manufacturing Ink

An example of a method for manufacturing the ink of the present disclosure will then be described. For example, the ink of the present disclosure can be prepared by mixing a specific particle dispersion liquid, a self-dispersing pigment dispersion liquid and the aqueous medium. For example, the specific particle dispersion liquid can be prepared by a method including: a kneading step of kneading the pigment and the resin to obtain a kneaded material; a pulverization step of pulverizing the kneaded material to obtain a pulverized material; and a dispersion step of dispersing the pulverized material in a solvent to obtain the specific particle dispersion liquid.

### Kneading Step

In the present step, the pigment and the resin are kneaded, and thus the kneaded material is obtained. Examples of a kneading device for kneading the pigment and the resin include a kneader kneading machine, a Banbury mixer kneading machine, a single screw extruder kneading machine, a twin screw extruder kneading machine and the like. As the kneading device, the twin screw extruder kneading machine is preferable.

For example, mixing conditions are that a rotation speed is equal to or greater than 1000 rpm and equal to or less than 3000 rpm and a mixing time is equal to or greater than 1 minute and equal to or less than 10 minutes. For example, the kneading conditions are that a shaft rotation speed is equal to or greater than 100 rpm and equal to or less than 200 rpm and a cylinder temperature is equal to or greater than 100° C. and equal to or less than 200° C.

### Pulverization Step

In the present step, the kneaded material obtained in the kneading step is cooled and is pulverized with a pulverizer, and thus a kneaded/pulverized material including the resin and the pigment is obtained. Examples of a method for pulverizing the kneaded material include a screen pulverizer and the like. The kneaded/pulverized material obtained may be subjected to the dispersion step without being processed. After the kneaded/pulverized material described above is further finely pulverized with a jet mill or the like, the kneaded/pulverized material may be subjected to the dispersion step after being classified with a classifier.

### Dispersion Step

In the present step, the kneaded/pulverized material obtained in the pulverization step is put into a dispersing device together with a solvent such as ion-exchanged water, and dispersion treatment is performed. In the dispersion treatment, for example, the kneaded/pulverized material is further finely pulverized, and thus the specific particles are formed. Consequently, the specific particle dispersion liquid in which the specific particles are dispersed in the solvent is obtained. As the dispersing device, a known device can be used, and examples thereof include a media-type disperser, a processor using a high-pressure emulsification method, an ultrasonic disperser, a high-pressure disperser, a dissolver which rotates special stirring blades at high speed to perform dispersion, a disperser, a high-speed impeller disperser, Dispermill which performs dispersion by a shearing force when passing through a fine gap between a rotor and a stator, TORNADO, Micro Blender, Cavitron, Homomixer and the like. As the dispersing device, the media-type disperser is preferable. In the present step, a basic compound may be added when the kneaded/pulverized material is dispersed. In this way, the resin included in the kneaded/pulverized material can be neutralized.

In the present step, the aqueous medium may be further added into the specific particle dispersion liquid obtained to perform a concentration adjustment. In the present step, on the specific particle dispersion liquid obtained, by means of centrifugation, filtering or the like, coarse particles or free resin (component in which the resin used in the kneading step is not incorporated into the specific particles and is released into the solvent) may be separated. When centrifugation is performed, for example, the centrifugation conditions can be set such that a centrifugation speed is equal to or greater than 10000 rpm and equal to or less than 100000 rpm and a treatment time is equal to or greater than 12 minutes and equal to or less than 48 minutes.

### PRACTICAL EXAMPLES

Practical Examples in the present disclosure will be described below, in comparison with comparative examples. However, the present disclosure is not limited to Examples below.

### GPC

The mass and the mass average molecular weight of a resin were quantified by gel filtration chromatography (GPC) under the following conditions. In the GPC, as necessary, a sample was filtered with a filter (pore diameter of 0.45 μm) before the measurement.

Measuring device: “HLC-8020GPC” made by Tosoh Corporation

Column: Column for ultra-high performance semi-micro SEC (“TSKgel Super Multipore HZ-H” made by Tosoh Corporation, filler: styrene-divinylbenzene resin, column size: inside diameter of 4.6 mm×length of 15 cm, filler particle diameter: 6 μm)
Number of columns: 3
Eluent: Tetrahydrofuran
Eluate flow rate: 0.35 mL/minute
Amount of sample solution: 10 μL
Column temperature: 40° C.
Detector: RI (refractive index) detector
Calibration curve: A calibration curve produced using monodisperse polystyrene standard samples made by Tosoh Corporation (F-40, F-20, F-4, F-1, A-5000, A-2500 and A-1000) and n-propylbenzene

### Volume Median Diameter (D₅₀)

Volume median diameters (D₅₀) in Examples were measured by a particle size distribution measurement using a dynamic light scattering particle size distribution measuring device (“Zetasizer Nano ZS” made by Malvern Panalytical Ltd).

### Measurement of Acid Value

Acid values in Examples were measured according to “JIS (Japanese Industrial Standard) K-0070: 1992”. Specifically, 1.0 g of the sample (mass M of the sample) and 25 mL of a mixed liquid of tetrahydrofuran and ethanol (tetrahydrofuran:ethanol=2:1) were put into a beaker, and the sample was dissolved in the mixed liquid, with the result that a sample solution was prepared. Then, neutralization titration was performed on the sample solution described above with 0.1 mol/L of a KOH ethanol solution using a potentiometric titration measuring device (“COM-2500” made by HIRANUMA Co., Ltd.). The amount of KOH ethanol solution used to neutralize the sample solution was assumed to be “S”. In addition, neutralization titration of the mixed liquid (calibration blank) described above was performed using the potentiometric titration measuring device and the KOH ethanol solution described above. The amount of KOH ethanol solution used to neutralize the mixed liquid was assumed to be “B”. “M”, “S” and “B” were applied to the following formula, and thus the acid value of the sample was calculated. In the following formula, “f” is a factor specific to the KOH solution.

acid value [mgKOH/g]=(S−B)×f×5.61/M

### Preparation of Self-Dispersing Pigment

100 g of carbon black (“Black Pearls (registered trademark) 1000” made by Cabot Corporation.) was added into 3,000 mL of a 2.5 N (normality) of sodium hypochlorite aqueous solution to obtain a dispersion liquid. The resulting dispersion liquid was reacted (oxidized) for 10 hours while being stirred at a temperature of 60° C. and a speed of 300 rpm to provide carboxyl groups to the surface of the carbon black. In this way, the dispersion liquid was obtained that included the carbon black (oxidized carbon black) to the surface of which the carboxyl groups were provided. The dispersion liquid was filtered to filter out the oxidized carbon black. A mixed liquid was obtained by adding an aqueous sodium hydroxide solution to the filtered carbon black oxide and neutralizing it. Then, the resulting mixed liquid was subjected to ultrafiltration to obtain a dispersion liquid including the oxidized carbon black which had been neutralized (self-dispersing pigment). Then, the dispersion liquid including the self-dispersing pigment was further subjected to ultrafiltration by a dialysis membrane using ion-exchanged water, and thus a water content was adjusted such that a solid content concentration was 60% by mass (water content of 40% by mass), with the result that a dispersion liquid (A-1) including the self-dispersing pigment was obtained. In the dispersion liquid (A-1), the volume median diameter (D₅₀) of the self-dispersing pigment was 110 nm.

### Preparation of Styrene-(meth)acrylic Resin

100.0 parts by mass of isopropyl alcohol and 250.0 parts by mass of methyl ethyl ketone were put into a four-necked flask equipped with a stirrer, a nitrogen gas inlet tube, a condenser and a dropping funnel. In addition, a mixed liquid was prepared which included 40.0 parts by mass of methyl methacrylate, 40.0 parts by mass of styrene, 10.0 parts by mass of n-butyl acrylate, 10.0 parts by mass of methacrylic acid, 0.3 parts by mass of azobisisobutyronitrile (AIBN, polymerization initiator). With nitrogen introduced into the flask and the contents refluxed by heating at 70° C., the mixed liquid described above was supplied into the flask from the dropping funnel over about 2 hours. Thereafter, the contents of the flask were refluxed by heating at 70° C. for another 6 hours. Thereafter, a methyl ethyl ketone solution including 150.0 parts by mass of methyl ethyl ketone and 0.1 parts by mass of AIBN was supplied into the flask from the dropping funnel over 15 minutes. Thereafter, the contents of the flask were refluxed by heating at 70° C. for 5 hours. Thereafter, a styrene-(meth)acrylic resin was obtained by distilling off methyl ethyl ketone from the contents of the flask under reduced pressure. The styrene-(meth)acrylic resin had an acid value of 100 mgKOH/g and a mass average molecular weight of 20000.

### Preparation of Dispersion Liquid

Dispersion liquids (B-1) to (B-8) below were prepared which were dispersion liquids including the specific particles.

### Dispersion Liquid (B-1)

An FM mixer (“FM-10B” made by NIPPON COKE & ENGINEERING CO., LTD.) was used to premix 168 parts by mass of the styrene-(meth)acrylic resin described above and 140 parts by mass of carbon black (“MA100” made by Mitsubishi Chemical Corporation, a pigment which does not have self-dispersibility) at a rotation speed of 2000 rpm for 4 minutes, with the result that a mixture was obtained. The resulting mixture was melt-kneaded with a twin screw extruder (“PCM-30” made by Ikegai Corp.) under the conditions of a melt-kneading temperature (cylinder temperature) of 120° C., a rotation speed of 150 rpm and a treatment speed of 100 g/minute. The resulting melt-kneaded material was coarsely pulverized to a set particle size of 6 μm using a pulverizer (“Rotoplex (registered trademark)” made by Hosokawa Micron Corporation) to obtain a kneaded/pulverized material.

Into the vessel of a media-type disperser (“DYNO-MILL” made by Willy A. Bachofen AG (WAB)), a predetermined amount (X parts by mass) of ion-exchanged water, a predetermined amount (V parts by mass) of the kneaded/pulverized material described above and 0.5 parts by mass of a nonionic surfactant (“Orfin (registered trademark) E1004” made by Nissin Chemical Co., Ltd., ethylene oxide adduct of acetylene diol) were put. Media (zirconia beads having a diameter of 1.0 mm) were filled in the vessel. The amount of media filled was set to 70% by volume with respect to the volume of the vessel. Then, a 1M NaOH aqueous solution (that is, 1 mol/L of a NaOH aqueous solution) was added into the vessel to neutralize the styrene-(meth)acrylic resin included in the kneaded/pulverized material. The mass of the 1M NaOH aqueous solution used was set to 0.8 times the neutralization equivalent of the styrene-(meth)acrylic resin.

The amount (X parts by mass) of ion-exchanged water put into the media-type disperser described above was adjusted such that 69.5 parts by mass of water was included in the contents of the vessel after the neutralization. Specifically, the amount (X parts by mass) of ion-exchanged water put was adjusted such that the total (X+Y+Z) of the amount (X parts by mass) of ion-exchanged water put, the mass (Y parts by mass) of water included in the 1M NaOH aqueous solution and the mass (Z parts by mass) of water generated by the neutralization reaction of NaOH included in the 1M NaOH aqueous solution and the styrene-(meth)acrylic resin was 69.5 parts by mass. The amount (V parts by mass) of kneaded/pulverized material put into the media-type disperser described above was adjusted such that the mass of the kneaded/pulverized material after the neutralization was 30.0 parts by mass. Specifically, the amount (W parts by mass) of kneaded/pulverized material put was adjusted such that the total (V+W) of the amount (V parts by mass) of kneaded/pulverized material put and the mass (W parts by mass) of Nat (Nat which was part of the styrene-(meth)acrylic resin due to the neutralization) included in the 1M NaOH aqueous solution was 30.0 parts by mass.

Thereafter, the media-type disperser described above was used, and thus the kneaded/pulverized material was wet-pulverized (finely pulverized) under conditions in which a discharge rate was 300 g/minute and the number of passes was one. In this way, a first dispersion liquid was obtained. In the first dispersion liquid, particles (specific particles) obtained by further finely pulverizing the kneaded/pulverized material, the nonionic surfactant and water were included.

The resulting first dispersion liquid was transferred to a container, and this container was placed in a centrifugal adhesion measuring device (“NS-C100” made by Nano Seeds Corporation.). The centrifugal adhesion measuring device was used, and thus the dispersion liquid described above was centrifuged at a rotational speed of 50000 rpm for 24 hours. After the centrifugation, a supernatant liquid was removed from the container, and thereafter, the same volume of ion-exchanged water as the removed supernatant liquid was added into the container. In this way, free resin was removed from the first dispersion liquid. Consequently, a dispersion liquid (B-1) was obtained. The dispersion liquid (B-1) includes water and the specific particles which were dispersed in water (a solid content concentration of 30% by mass).

### Dispersion Liquids (B-2) to (B-8)

Dispersion liquids (B-2) to (B-8) were prepared by the same method as in the preparation of the dispersion liquid (B-1) except that the mass of the styrene-(meth)acrylic resin used in the melt-kneading, the mass of the pigment used in the melt-kneading and the amount of 1M NaOH aqueous solution used in the neutralization of the kneaded/pulverized material were changed as shown in Table 1 below. In Table 1 below, “NaOH [neutralization equivalent ratio]” indicates the amount of 1M NaOH aqueous solution used in the neutralization of the kneaded/pulverized material. The neutralization equivalent ratio indicates a ratio (N2/N1) of the mass N2 of the 1M NaOH aqueous solution actually used to the mass N1 of the 1M NaOH aqueous solution necessary for the complete neutralization of the styrene-(meth)acrylic resin included in the kneaded/pulverized material.

The volume median diameters of the specific particles included in the dispersion liquids (B-2) to (B-8) were measured. The results of the measurements are shown in Table 1 below.

TABLE 1

| | Resin | Pigment | NaOH aqueous solution | |
|---|---|---|---|---|
| | [parts by | [parts by | [neutralization equivalent | D₅₀ |
| | mass] | mass] | ratio] | [nm] |
| B-1 | 168 | 140 | 0.8 | 120 |
| B-2 | 168 | 140 | 0.6 | 160 |
| B-3 | 205 | 100 | 0.8 | 120 |
| B-4 | 205 | 100 | 0.6 | 160 |
| B-5 | 168 | 140 | 0.5 | 180 |
| B-6 | 168 | 140 | 1.0 | 80 |
| B-7 | 220 | 100 | 0.5 | 180 |
| B-8 | 110 | 100 | 1.0 | 80 |

### Preparation of Ink

Inks in Practical Examples 1 to 4 and Comparative Examples 1 to 4 were prepared by the following method.

### Practical Example 1

8.6 parts by mass of the dispersion liquid (A-1) including the self-dispersing pigment (5.2 parts by mass of the self-dispersing pigment), 16.6 parts by mass of the dispersion liquid (B-1) including the specific particles, 20.0 parts by mass of ethylene glycol, 15.0 parts by mass of diethylene glycol and 0.3 parts by mass of the nonionic surfactant (“Orfin (registered trademark) E1004” made by Nissin Chemical Co., Ltd., ethylene oxide adduct of acetylene diol) were put into a container. A stirrer (“Three-One Motor BL-600” made by Shinto Scientific Co., Ltd.) was used to stir the contents of the container at a rotation speed of 400 rpm and to uniformly mix the contents of the container. The resulting mixed liquid was filtered using a membrane filter (pore diameter of 5μm) to obtain the ink in Example 1.

### Practical Examples 2 to 4 and Comparative Examples 1 to 4

The inks in Practical Examples 2 to 4 and Comparative Examples 1 to 4 were prepared by the same method as in the preparation of the ink in Example 1 except that the types and amounts of raw materials used were changed as shown in Table 2 below.

### Measurement of Ratio (Resin/Pigment)

By the following method, for the inks in Practical Examples 1 to 4 and Comparative Examples 1 to 4, the mass ratio (which may also be referred to as a “ratio (resin/pigment)” below) of the resin to the pigment in the specific particles included in the inks was measured. The results of the measurements are shown in Table 2 below.

A measurement target (any one of the inks in Practical Examples 1 to 4 and Comparative Examples 1 to 4) was first put into a reduced-pressure oven. Here, the amount of measurement target put was set to a mass W [g]. Then, the temperature and the pressure of the reduced-pressure oven were set to 150° C. and 0.67 Pa, respectively, and thus an aqueous medium was evaporated from the measurement target. In this way, a first solid content was obtained. The gel filtration chromatography (GPC) described above was used to measure the amount M₁ of resin included in the first solid content (the total of the amount of styrene-(meth)acrylic resin included in the specific particles and the amount of free resin).

In addition, the measurement target of the mass W [g] was transferred to a container, and this container was placed in a centrifugal adhesion measuring device (“NS-C100” made by Nano Seeds Corporation.). The centrifugal adhesion measuring device was used, and the measurement target described above was centrifuged at a rotational speed of 50000 rpm for 24 hours. After the centrifugation, a supernatant liquid was collected from the container. The collected supernatant liquid was put into the reduced-pressure oven. Then, the temperature and the pressure of the reduced-pressure oven were set to 150° C. and 0.67 Pa, respectively, and thus the aqueous medium was evaporated from the supernatant liquid. In this way, a second solid content was obtained. The gel filtration chromatography (GPC) was used to measure the amount M₂ of resin included in the second solid content (the amount of free resin).

The amount M₁ of resin included in the first solid content, the amount M₂ of resin included in the second solid content and the mass of the pigment were applied to a formula below. In this way, the ratio (resin/pigment) in the specific particles was calculated. The mass of the pigment was calculated by multiplying the mass W [g] of the measurement target and the content of the pigment (pigment which did not have self-dispersibility) in the measurement target.

ratio (resin/pigment)=(amount M₁ of resin included in first solid content−amount M₂ of resin included in second solid content)/mass of the pigment

### Evaluations

By the following method, for the inks in Practical Examples 1 to 4 and Comparative Examples 1 to 4, the image density and the abrasion resistance of formed images were evaluated. Unless otherwise specified, the evaluations were performed at a temperature of 25° C. and a humidity of 60% RH. The results of the evaluations are shown in Table 2 below.

TABLE 2

| | | Practical Examples | | | | Comparative Examples | | | |
|---|---|---|---|---|---|---|---|---|---|
| | | 1 | 2 | 3 | 4 | 1 | 2 | 3 | 4 |
| Dispersion | A-1 | 8.3 | 8.3 | 8.3 | 8.3 | 8.3 | 8.3 | 8.3 | 8.3 |
| liquid (parts by mass) | B-1 | 16.6 | — | — | — | — | — | — | — |
| | B-2 | — | 16.6 | — | — | — | — | — | — |
| | B-3 | — | — | 16.6 | — | — | — | — | — |
| | B-4 | — | — | — | 16.6 | — | — | — | — |
| | B-5 | — | — | — | — | 16.6 | — | — | — |
| | B-6 | — | — | — | — | — | 16.6 | — | — |
| | B-7 | — | — | — | — | — | — | 16.6 | — |
| | B-8 | — | — | — | — | — | — | — | 16.6 |
| Aqueous | Ethylene | 20.0 | 20.0 | 20.0 | 20.0 | 20.0 | 20.0 | 20.0 | 20.0 |
| medium (parts by mass) | glycol | | | | | | | | |
| | Diethylene glycol | 15.0 | 15.0 | 15.0 | 15.0 | 15.0 | 15.0 | 15.0 | 15.0 |
| | Surfactant | 0.3 | 0.3 | 0.3 | 0.3 | 0.3 | 0.3 | 0.3 | 0.3 |
| | Water | 34.8 | 34.8 | 34.8 | 34.8 | 34.8 | 34.8 | 34.8 | 34.8 |
| Self-dispersing pigment D₅₀ [nm] | | 110 | 110 | 110 | 110 | 110 | 110 | 110 | 110 |
| Specific particles D50 [nm] | | 120 | 160 | 120 | 160 | 180 | 80 | 180 | 80 |
| Ratio (resin/pigment) | | 1.2 | 1.2 | 2.0 | 2.0 | 1.2 | 1.2 | 2.1 | 1.1 |
| Evaluation results | Image density | A | A | A | A | B | A | B | A |
| | Abrasion | A | A | A | A | A | B | A | B |
| | resistance | | | | | | | | |

### Evaluation Machine

As an evaluation machine, an inkjet printer (“PX-049A” made by Seiko Epson Corporation) was used. The measurement target (any one of the inks in Practical Examples 1 to 4 and Comparative Examples 1 to 4) was filled in one of recording heads in the evaluation machine.

### Abrasion Resistance

The evaluation machine was used to form a solid image (size of 2 cm×2 cm) on a recording medium (a PET OHP sheet of an A4 size in which corona treatment was performed on a recoding surface). Then, a dryer was used to dry the recording medium at 60° C. for 2 hours. Then, the recording medium was passed through a fixing device (having a setting temperature of 160° C.), and thus fixing treatment was performed. The fixing device was a fixing device which was removed from a multi-functional peripheral (“TASKalfa2551ci” made by KYOCERA Document Solutions Inc.).

Then, an abrasion test was performed on the recording medium described above. Specifically, a metal weight (having a cylindrical shape with a diameter of 50 mm and a mass of 1 kg) in which a bottom surface was covered with cloth was placed on the solid image formed on the recording medium described above. Then, the weight was used, and thus the solid image was rubbed back and forth 10 times with a load of 1 kg. Then, the solid image was visually observed, and whether or not the solid image was separated from the OHP sheet was checked. The abrasion resistance was determined according to the following criterion.

### Criterion for Abrasion Resistance

A (satisfactory): separation of solid image was not confirmed
B (faulty): separation of solid image was confirmed

### Image Density

The evaluation machine was used to form a solid image of 25 mm×25 mm on one sheet of printing paper (“COLOR COPY (registered trademark) 90” made by Mondi BP Co., Ltd.). The sheet of printing paper on which the solid image was formed was stored for 24 hours in a normal temperature and normal humidity environment. Thereafter, the image density (ID) of the solid image formed on the sheet of printing paper was measured using a reflection densitometer (“eXact” made by X-Rite, Incorporated.). The image density was evaluated according to the following evaluation criterion.

### Evaluation Criterion of Image Density

A (satisfactory): ID was equal to or greater than 1.30
B (faulty): ID was less than 1.30

As shown in Tables 1 and 2, the inks in Practical Examples 1 to 4 included the self-dispersing pigment, the specific particles and the aqueous medium. The specific particles included the pigment and the resin. In the specific particles, the mass ratio of the resin to the pigment was equal to or greater than 1.2 and equal to or less than 2.0. The resin included the styrene-(meth)acrylic resin. The volume median diameter of the specific particles was equal to or greater than 100 nm and equal to or less than 170 nm. In the inks in Practical Examples 1 to 4, the image density and the abrasion resistance of the formed images were satisfactory.

On the other hand, in the ink in Comparative Example 1, the volume median diameter of the specific particles was greater than 170 nm. In the image formed with the ink in Comparative Example 1, it was determined that the self-dispersing pigment was excessively coated with the specific particles and thus the image density was insufficient.

In the ink in Comparative Example 2, the volume median diameter of the specific particles was less than 100 nm. In the image formed with the ink in Comparative Example 2, it was determined that the self-dispersing pigment was not sufficiently coated with the specific particles and thus the abrasion resistance was insufficient.

In the ink in Comparative Example 3, the ratio (resin/pigment) in the specific particles was greater than 2.0. In the image formed with the ink in Comparative Example 3, it was determined that the amount of resin was excessive and thus the image density was insufficient.

In the ink in Comparative Example 4, the ratio (resin/pigment) in the specific particles was less than 1.2. In the image formed with the ink in Comparative Example 4, it was determined that the amount of resin was low and thus the abrasion resistance was insufficient.

The inkjet ink of the present disclosure can form images which have a desired image density and excellent abrasion resistance.

The ink of the present disclosure can be used to form images.

What is claimed is:

1. An inkjet ink comprising:
a self-dispersing pigment;
specific particles; and
an aqueous medium,
wherein the specific particles include a pigment and a resin,
in the specific particles, a mass ratio of the resin to the pigment is equal to or greater than 1.2 and equal to or less than 2.0,
the resin includes a styrene-(meth)acrylic resin and
a volume median diameter of the specific particles is equal to or greater than 100 nm and equal to or less than 170 nm.

2. The inkjet ink according to claim 1,
wherein a content of the self-dispersing pigment is equal to or greater than 2.0% by mass and equal to or less than 8.0% by mass.

3. The inkjet ink according to claim 1,
wherein a content of the specific particles is equal to or greater than 2.0% by mass and equal to or less than 8.0% by mass.

4. The inkjet ink according to claim 1,
wherein a mass ratio of the specific particles to the self-dispersing pigment is equal to or greater than 0.5 and equal to or less than 2.0.

5. The inkjet ink according to claim 1,
wherein the specific particles are a material obtained by kneading and pulverizing the pigment and the resin.

6. The inkjet ink according to claim 1,
wherein the styrene-(meth)acrylic resin includes a repeating unit derived from (meth)acrylic acid.
